(19) United States
(12) Patent Application Publication
(10) Pub. No.: US 2022/0112878 A1
(43) Pub. Date: Apr. 14, 2022

(54) METHOD AND SYSTEM FOR CONTROLLING A WIND TURBINE

(71) Applicant: Siemens Gamesa Renewable Energy Service GmbH, Hamburg (DE)

(72) Inventors: Svenja Wortmann, Rendsburg (DE); Timo Gosch-Pless, Osterrönfeld (DE)

(21) Appl. No.: 17/421,934

(22) PCT Filed: Dec. 23, 2019
(86) PCT No.: PCT/EP2019/086889

§ 371 Date: Jul. 9, 2021

(30) Foreign Application Priority Data
Jan. 10, 2019 (DE) 10 2019 000 097.8

(51) Int. Cl. F03D 7/02; F03D 7/04

(52) U.S. Cl. CPC F03D 7/024; F03D 7/0224; F03D 7/04; F05B 2270/335; F05B 2270/327; F05B 2270/3201; F05B 2270/328

(57) ABSTRACT

A method for controlling a wind turbine having a rotor with at least two rotor blades, a 1P individual blade controller for individually adjusting the rotor blades in cycles about the respective longitudinal axis of the rotor blades using a first rotor assembly, and partial and full load ranges which adjoin each other in a nominal operating point. The method includes activating the controller, in particular by gradually increasing the controller, if the value of a first operating variable of the wind turbine exceeds a specified lower threshold which the operating variable has at a first operating point of the wind turbine, the first operating point lying in the partial or full load range or being the nominal operating point; and/or deactivating the controller, in particular by gradually reducing the controller, if the value of the first or a second operating variable of the wind turbine exceeds a specified upper threshold which the operating variable has below a switch-off wind speed of the wind turbine, in particular at a second wind turbine operating point which lies in the full load range.

### CROSS-REFERENCE TO RELATED APPLICATIONS

This application is a national phase application under 35 U.S.C. § 371 of International Patent Application No. PCT/EP2019/086889, filed Dec. 23, 2019 (pending), which claims the benefit of priority to German Patent Application No. DE 10 2019 000 097.8, filed Jan. 10 2019, the disclosures of which are incorporated by reference herein in their entirety.

### TECHNICAL FIELD

The present invention relates to a method and a system for controlling a wind turbine, and to a computer program product for carrying out the method.

### BACKGROUND

EP 2 500 562 A2 discloses a combined 1P and 2P individual blade control in which the rotor blades of a rotor of a wind turbine are, in addition to a collective adjustment, individually adjusted cyclically about their respective longitudinal axis.

### SUMMARY

The object of the present invention is to improve the operation of a wind turbine—in particular, its performance and/or load or service life.

This object is achieved by a method and a system or computer program product for carrying out the method as described herein.

According to one embodiment of the present invention, a wind turbine comprises
a rotor having at least two—preferably three or more—rotor blades,
a partial load range and a full load range adjoining one another at a nominal operating point, and
an 1P individual blade control that—particularly in addition to a collective blade adjustment—individually adjusts at least two—preferably all—rotor blades (respectively) cyclically about their respective longitudinal axis with a first rotor order or is configured or used for this purpose—in particular, outputs corresponding blade pitch adjustment or setting signals.

In one embodiment, the rotor—in particular, a rotor shaft—is pivoted about a rotational axis in a nacelle, which, in one embodiment, is arranged on a tower of the wind turbine to be rotatable—in particular, adjustable by means of at least one actuator—about a yaw axis. The rotation or longitudinal axis of the rotor or of the rotor shaft forms, with the gravitational direction, in one embodiment an angle which is at least 70 degrees and/or at most 110 degrees, and, with the yaw axis, in one embodiment an angle which is at least 75 degrees and/or at most 105 degrees. In other words, the rotor in one embodiment is a horizontal rotor, and/or the nacelle is rotatable or (actively) adjustable about the vertical.

In such wind turbines, the present invention can be used with particular advantage.

In one embodiment, the partial load range extends from a switch-on wind velocity or power, which in one embodiment is greater than zero, up to the nominal operating point—in particular, a nominal wind velocity or power; in one embodiment, the full load range, correspondingly, from the nominal operating point up to a switch-off wind velocity or power. In one embodiment, the nominal operating point is defined by a nominal wind velocity and/or a nominal rotational velocity, nominal power or nominal torque of the wind turbine or of the rotor. In one embodiment, the nominal operating point or the nominal rotational velocity or power or the nominal torque of the wind turbine is the operating point or the rotational velocity or power or the torque that the wind turbine can at most realize for at least 1 hour and/or at which the partial and full load ranges adjoin one another.

In one embodiment, a first rotor order corresponds to the rotational velocity—in particular, the current rotational velocity—of the rotor about its axis of rotation.

By means of a 1P single blade control, the rotor blades are adjusted cyclically over one rotation—preferably corresponding to a sine or cosine function or the like.

In one embodiment, loads, which are constant in an environmentally- or tower-fixed (inertial or coordinate) system and correspondingly occur for the rotor blades rotating at the rotor rotational velocity or in a co-rotating (rotor or coordinate) system with the rotor rotational velocity or first rotor assembly, can, advantageously, be at least partially compensated for, and, in particular, the load on the wind turbine thus reduced or its service life extended.

According to one embodiment of the present invention, this 1P individual blade control is activated if (it is detected that) a value of a first operating variable—in particular, a wind-velocity-dependent operating variable—of the wind turbine exceeds a specified lower threshold value which this first operating variable comprises at a first operating point of the wind turbine which is in the partial-load range or the full-load range or is the nominal operating point—in one embodiment, by gradually increasing the 1P individual blade control.

Additionally or alternatively, the 1P individual blade control is deactivated according to one embodiment of the present invention if (it is detected that) a value of this first operating variable, or of a second, divergent operating variable, which is in particular dependent upon the wind velocity, of the wind turbine exceeds a specified upper limit value which comprises this (first or second) operating variable below a switch-off wind velocity of the wind turbine—in one embodiment, at a second operating point of the wind turbine which is in the full-load range—in one embodiment, by gradually reducing the 1P individual blade control.

Thus, in one embodiment, the 1P individual blade control is activated only from a first or partial load operating point onwards in the partial load range or at the nominal operating point separating the partial and full load range, and/or already deactivated (again) below the switch-off wind velocity of the wind turbine—in particular, from a second or full load operating point in the full load range onwards—in particular, therefore, only in a part of the operating range (providing electrical energy) between the switch-on and switch-off wind velocity or power, which in one embodiment comprises the nominal operating point.

As a result, in one embodiment, a load on the bearings and/or drives of the rotor blades or (individual) rotor blade adjustment can in each case—in particular, in combination—advantageously be reduced and, in particular, the load on the wind turbine thus be reduced or the service life thereof extended.

In one embodiment, in addition to the 1P individual blade control, the wind turbine comprises an nP individual blade control that individually adjusts at least two—preferably, all—rotor blades (respectively) cyclically about their respective longitudinal axis with an nth rotor order or is configured or used for this purpose—in particular, outputs corresponding blade pitch adjustment or setting signals, wherein n is a whole number greater than 1 and, in a preferred embodiment, is equal to 2 and/or equal to the (total) number of rotor blades of the rotor minus 1. In one embodiment, the nP individual blade control—in particular, in the case of a three-blade rotor—is thus a so-called 2P individual blade control, as is known in principle from, for example, EP 2 500 562 A2, to which reference is additionally made and the contents of which are completely incorporated into the present disclosure.

In one embodiment, the nth rotor order thus corresponds to n times the—in particular, current—rotational velocity of the rotor about its axis of rotation.

By means of such an nP individual blade control, the rotor blades are adjusted within one rotation, preferably corresponding to a sine or cosine function or the like, with several or n cycles.

In one embodiment, loads—in particular, loads that are caused or amplified by the plurality N of rotor blades, and correspondingly occur in an environmentally- or tower-fixed (inertial or coordinate) system with the Nth rotor order or the N times the rotor rotational velocity and for the rotor blades rotating at the rotor rotational velocity or in a co-rotating (rotor or coordinate) system with the (N−1)th rotor order or (N−1) times the rotor rotational velocity—can, advantageously, be at least partially compensated for, and, in particular, the load on the wind turbine thus be (further) reduced or its service life (further) extended.

In one embodiment, this additional nP individual blade control is activated if (it is detected that) a value of an operating variable of the wind turbine—in particular of the first, second, or of a third, divergent operating variable, which is in particular dependent upon the wind velocity—exceeds a specified lower limit value—in one embodiment, by gradually increasing said nP individual blade control.

Additionally or alternatively, the additional nP individual blade control is deactivated according to one embodiment of the present invention if (it is detected that) a value of the first, second, third, or of a different, fourth operating variable, which is in particular dependent upon the wind velocity, of the wind turbine exceeds a specified upper limit value—in one embodiment, by gradually reducing said nP individual blade control.

Thus, in one embodiment, the nP individual blade control is activated only from an operating point onwards at which the corresponding operating variable exceeds the lower limit value, and/or is already deactivated (again) from an operating point onwards at which the corresponding operating variable exceeds the upper limit value—in particular, therefore, only in a part of the operating range (providing electrical energy) between the switch-on and switch-off wind velocity or power, which in one embodiment comprises the nominal operating point.

As a result, in one embodiment, a load on the bearings and/or drives of the rotor blades or (individual) rotor blade adjustment can, advantageously, be (further) reduced, and, in particular, the load on the wind turbine thus (further) reduced or the service life thereof (further) extended.

In one embodiment, the first, second, third, and/or fourth operating variables are a function (in each case) of
a generator torque,
a rotational velocity,
a power,
a collective adjustment or a collective blade pitch of the rotor blades about their respective longitudinal axis,
a wind velocity, averaged, in particular, over a specified period of time, which in one embodiment is at least 10 seconds and/or at most 60 seconds—preferably, at least substantially, 30 seconds,
a blade bending torque, and/or
a rotor thrust—in particular, a thrust in the direction of the axis of rotation—if this is specified in an embodiment.

Said operating variables have proven to be particularly suitable for an—in particular, simple, precise, and/or reliable—(de)activation of the 1P or nP individual blade control.

In one embodiment, the first and second operating variables are different (diverse) operating variables, or the 1P individual blade control is activated and deactivated based upon different operating variables. In a preferred embodiment, the first operating variable is a function of or delimits a torque, and the second operating variable is a function of or delimits a collective blade pitch, and can, in particular, specify it.

As a result, the activation and deactivation can in one embodiment be realized particularly precisely and/or reliably.

Additionally or alternatively, in one embodiment, the first, second, third, and/or fourth operating variables (respectively) can be a function of a setpoint value, determined in one embodiment during operation—in particular, of a controller or of a controller-internal setpoint value—and, in particular, can be such a value.

As a result, in one embodiment—in particular, in comparison to the use of actual values detected with measuring errors, delays, and the like—the 1P or nP individual blade control can be (de)activated (more) simply, (more) precisely, and/or (more) reliably. In a preferred embodiment, the corresponding operating variable (respectively) can be a function of an integral component of a controller of the wind turbine—in particular, of a torque or blade pitch velocity controller—and, in particular, can be such a component. In one embodiment, an advantageous filtering effect of the corresponding operating variable can, thereby, be used.

In one embodiment, the first operating point is within a load range at which the wind turbine comprises
at least 65 percent—in particular, at least 80 percent, and/or
at most 110 percent—in particular, at most 99 percent—in one embodiment, at most 95 percent—of its nominal rotational velocity and/or
at least 35 percent and/or at most 65 percent of its nominal torque; and/or
at least 55 percent and/or at most 85 percent of its thrust in the longitudinal direction of the axis of rotation or rotor shaft when its nominal power is reached;
   in one embodiment, the lower limit value corresponds to an operating state below or in the range of the nominal wind velocity or rotational velocity—in particular, between 80 percent and 99 percent—of the nominal rotational velocity, and/or to an operating state of the wind turbine at 55 percent-85 percent of its thrust in the longitudinal direction of the axis of rotation or rotor shaft when its nominal power is reached, and/or to an operating state of the wind turbine at approximately 50 percent of its nominal torque.

In one embodiment, the 1P individual blade control is thus activated in a—for this purpose—particularly advantageous and, in particular, advantageously identifiable partial load operation or at the nominal operating point.

Additionally or alternatively, in one embodiment, the second operating point is in a (full) load range in which the rotor blades comprise an—in particular, collective or maximum—blade pitch
between 0 degrees and 10 degrees—in particular, between 1 degree and 8 degrees, or
between 13 degrees and 37 degrees—in particular, between 15 degrees and 35 degrees,
   and/or
the wind turbine comprises at least 45 percent and/or at most 75 percent of its thrust in the longitudinal direction of the axis of rotation or rotor shaft when its nominal power is reached; in one embodiment, the upper limit value corresponds to an operating state with a blade pitch in the range of—at least substantially—1 degree-8 degrees or 15 degrees-35 degrees and/or an operating state at 50 percent-70 percent of a thrust in the longitudinal direction of the axis of rotation or rotor shaft when the nominal power is achieved.

Deactivation upon reaching an (upper threshold) blade pitch between 0 degrees and 10 degrees—in particular, between 1 degree and 8 degrees—can, particularly advantageously, reduce extreme loads; a deactivation upon reaching an (upper threshold) blade pitch between 13 degrees and 37 degrees—in particular, between 15 degrees and 35 degrees—can, particularly advantageously, reduce fatigue loads. In one embodiment, said blade pitches are defined with respect to a position in which the rotor converts the wind energy to the maximum.

In the present case, a gradual increase or reduction is understood to mean, in particular, an increase or reduction of an amplitude—in particular, a maximum amplitude—of the 1P or nP individual blade control from zero to a maximum or final value or from a maximum or initial value to zero over a specified interval.

As a result, in one embodiment, the corresponding individual blade control can be (more) gently faded in or out, and thus, in particular, a sudden load or sudden intervention in the operation of the wind turbine can be avoided or reduced.

In one embodiment, a gradual increase of the 1P individual blade control comprises an, in particular, continuous—in one embodiment, linear or proportional—increase of the 1P individual blade control—in particular, of an amplitude of the 1P individual blade control—with (increasing value) of the first operating variable from an—in particular, minimum—start-up value, which can, in particular, be equal to zero, at the lower limit value or when the lower limit value is exceeded, up to an—in particular, maximum—final value at the end of the specified interval.

Analogously, in one embodiment, a gradual reduction of the 1P individual blade control comprises an, in particular, continuous—in one embodiment, linear or proportional—reduction of the 1P individual blade control—in particular, of an amplitude of the 1P individual blade control, with (increasing value) of the first or second operating variable from an—in particular, maximum—initial value up to an—in particular, minimum—run-out value, which can, in particular, be equal to zero, within the interval specified for this purpose.

Analogously, in one embodiment, a gradual increase of the nP individual blade control comprises an, in particular, continuous—in one embodiment, linear or proportional—increase of the nP individual blade control—in particular, of an amplitude of the nP individual blade control—with (increasing value) of the first, second, or third operating variables from an—in particular, minimum—start-up value of the nP individual blade control, which may, in particular, be equal to zero, at the lower limit value or when the lower limit value is exceeded, up to an—in particular, maximum—end value within the time interval specified for this purpose, and/or a gradual reduction of the nP individual blade control comprises an, in particular, continuous—in one embodiment, linear or proportional—reduction of the nP individual blade control—in particular, of an amplitude of the nP individual blade control—with (increasing value) of the first, second, third, or fourth operating variables from an—in particular, maximum—initial value of the nP individual blade control to an—in particular, minimum—run-out value, which may, in particular, be equal to zero, within the interval specified for this purpose.

In one embodiment, the gradual increase and/or the gradual reduction in the 1P individual blade control and/or the nP individual blade control (respectively) takes place over an interval of at least 5 percent and/or at most 45 percent of a or of the nominal torque of the wind turbine and/or of at least 2 degrees of the (collective) blade pitch.

Similarly, the gradual increase and/or reduction of the 1P and/or nP individual blade control can in each case take place over a specified time interval; in particular, therefore, the 1P individual blade control, within a time period specified for this purpose, can be increased, in particular, continuously—in one embodiment, linearly—if the value of the first operating variable exceeds the lower threshold value; the 1P individual blade control can be reduced within a time period specified for this purpose, in particular, continuously—in one embodiment, linearly—if the value of the first or second operating variable exceeds the upper threshold value; the nP individual blade control can be increased, in particular, continuously—in one embodiment, linearly—within a time period specified for this purpose if the value of the first, second, or third operating variable exceeds the lower limit value; and/or the nP individual blade control can be reduced, in particular, continuously—in one embodiment, linearly—within a period specified for this purpose if the value of the first, second, third, or fourth operating variable exceeds the upper limit value.

In one embodiment, the corresponding individual blade control can in each case, particularly advantageously, be faded in or faded out—in particular, equally gently or quickly.

In one embodiment, the lower limit value corresponds to a lower wind velocity or to a wind turbine operating point at a lower wind velocity than the lower limit value.

Additionally or alternatively, in one embodiment, the upper limit value corresponds to a lower wind velocity or to an operating point of the wind turbine at a lower wind velocity than the upper limit value.

In other words, in one embodiment, the nP individual blade control is activated and/or deactivated (again) earlier when the wind picks up than the 1P individual blade control.

Additionally or alternatively, in one embodiment, the lower limit value corresponds to a lower wind velocity or to an operating point of the wind turbine at a lower wind velocity than the upper limit value, and/or the lower limit value corresponds to a lower wind velocity or an operating point of the wind turbine at a lower wind velocity than the upper limit value.

In other words, in one embodiment, the 1P or nP individual blade control is first activated and then deactivated when the wind picks up.

Additionally or alternatively, in one embodiment, an operating range interval of the wind turbine—in particular, a corresponding wind velocity interval—between the lower and upper limit values, is smaller in one embodiment by at least 20 percent—in particular, by at least 30 percent; in one embodiment, by at least 40 percent—than an operating range interval of the wind turbine—in particular, a corresponding wind velocity interval—between the lower and upper threshold values.

In other words, in one embodiment, the nP individual blade control is carried out only over a narrower operating range or wind velocity interval than the 1P individual blade control.

It has surprisingly been found that particularly advantageous results can be achieved in particular by such a differentiated 1P and nP individual blade control—in particular, in combination.

According to one embodiment of the present invention, a system for controlling the wind turbine—in particular, in terms of hardware and/or software; in particular, in terms of programming—is configured to carry out a method described here and/or comprises:

means for activating the 1P individual blade control if a value of a first operating variable of the wind turbine exceeds a specified lower limit value which this operating variable comprises at a first operating point of the wind turbine which is in the partial load range or the full load range or is the nominal operating point—in particular, by gradually increasing the 1P individual blade control; and/or
means for deactivating the 1P individual blade control if a value of the first or of a second operating variable of the wind turbine exceeds a specified upper limit value which this operating variable comprises below a switch-off wind velocity of the wind turbine—in particular, at a second operating point of the wind turbine which is in the full-load range—in particular, by gradually reducing the 1P individual blade control.

In one embodiment, the system or its means comprises an additional nP single blade control for the individual cyclical adjustment of the rotor blades about their respective longitudinal axis with an nth rotor order, and

means for activating the nP individual blade control if a value of an operating variable of the wind turbine exceeds a specified lower limit value—in particular, by gradually increasing the nP individual blade control; and/or
means for deactivating the nP individual blade control if a value of an operating variable of the wind turbine exceeds a specified upper limit value—in particular, by gradually reducing the nP individual blade control.

A means in the sense of the present invention can be designed in terms of hardware and/or software—in particular, an, in particular, digital, processing, in particular, microprocessor unit (CPU) preferably connected to a memory and/or bus system by data or signal, a graphics card (GPU) or the like—and/or comprise one or more programs or program modules. The processing unit may be designed to process commands implemented as a program stored in a memory system, to detect input signals from a data bus, and/or to deliver output signals to a data bus. A memory system can comprise one or more—in particular, different—storage media—in particular, optical, magnetic, solid-state, and/or other non-volatile media. The program can be designed in such a way that it can be embodied or carried out by the methods described herein, so that the processing unit can carry out the steps of such methods and can thus in particular control the wind turbine. In one embodiment, a computer program product can comprise—in particular, be—an—in particular, non-volatile—storage medium for storing a program or with a program stored thereon, wherein running this program causes a system or a controller—in particular, a computer—to execute a method described herein or one or more of its steps.

In one embodiment, one or more—in particular, all—steps of the method are carried out completely or partially automatically—in particular, by the controller or its means.

In one embodiment, the system comprises the wind turbine.

Controlling, in the sense of the present invention, can comprise—in particular, be—in particular, a control or the determination and/or output of signals—in particular, controlled variables—as a function of actual variables—in particular, those detected by measurement technology—and/or specified setpoint variables.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 depicts an exemplary system for controlling a wind turbine according to one embodiment of the present invention;

FIG. 2 illustrates a method for controlling the wind turbine according to one embodiment of the present invention;

FIG. 3 depicts a blade pitch adjustment signal of a 1P and 2P individual blade control; and

FIG. 4 shows graphs depicting a partial load range, full load range, and nominal operating point of the wind turbine.

### DETAILED DESCRIPTION

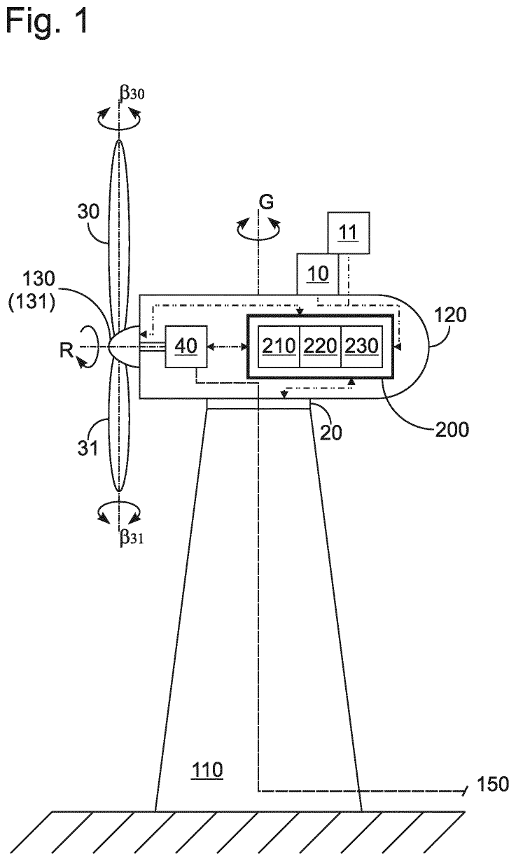

FIG. 1 shows a wind turbine with a tower 110 on which a nacelle 120 can be rotated, and thus track the wind, about a vertical yaw axis G by an actuator 20. In the nacelle 120, a rotor 130 is rotatably mounted about a horizontal axis of rotation R.

The rotor 130 has three rotor blades distributed equidistantly over the circumference, two rotor blades 30, 31 of which can be seen in the side view of FIG. 1. It is coupled to a generator 40, which supplies electric power to a power grid 150.

An operating guidance system 200 determines a wind velocity by means of an anemometer 10 combined with a wind vane 11 and controls the actuator 20 to track the nacelle 120 to the wind. A controller integrated into the operating system controls a generator torque of the generator 40 as well as blade pitch actuators 131 of the rotor 130 in order to adjust the blade pitches β of the rotor blades about their respective longitudinal axis, as shown in FIG. 1 by β₃₀ and β₃₁. The operating management system or controller controls or regulates the wind tracking, blade pitch adjustment, or generator torque in one embodiment on the basis of a detected rotor and/or generator rotational velocity, of the detected wind velocity—in particular, its magnitude and/or direction—and/or of other input variables, e.g., detected loads—in particular, blade loads, accelerations or the like.

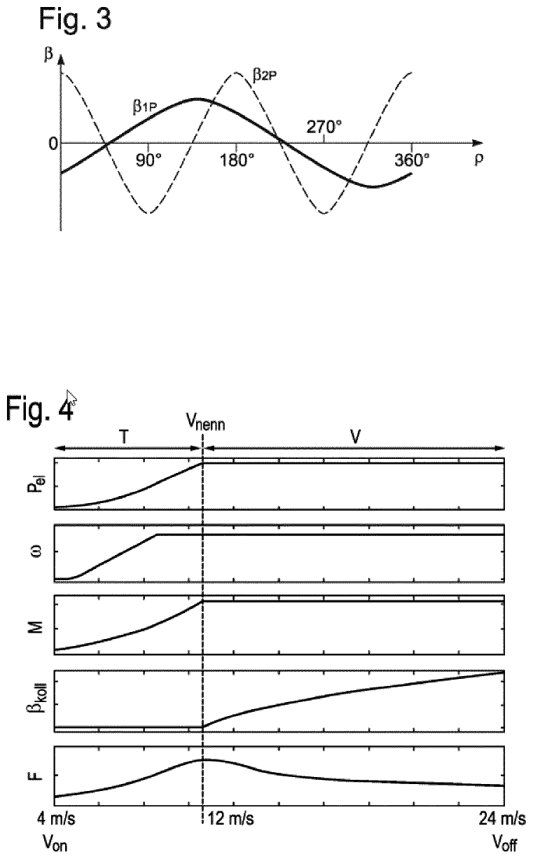

FIG. 3 shows a blade pitch adjustment signal β_{1P} of a 1P individual blade control (in bold in FIG. 3) and a blade pitch adjustment signal β_{2P} of a 2P individual blade control (thin dashed lines in FIG. 3) over a full rotation of the rotor or a rotor pitch ρ of 0 degrees to 360 degrees.

Both blade pitch adjustment signals β_{1P}, β_{2P} are sinusoidal, phase shifted with respect to one another, and comprise different (maximum) amplitudes, wherein, in a modification (not shown), the blade pitch adjustment signal of the 1P individual blade control and the 2P individual blade control may also comprise the same phase and/or (maximum) amplitudes, or even a non-sinusoidal profile.

The blade pitch adjustment signal β_{1P} is determined by a 1P individual blade control 210 of the operating management system 200, and the blade pitch adjustment signal β_{2P} is determined by a 2P individual blade control 220 of the operating management system 200. In addition, a collective blade control 230 of the operating control system 200 determines a collective blade pitch, which is constant in FIG. 3 or over one rotation of the rotor.

The operating management system 200 superimposes this and the two blade pitch adjustment signals β_{1P}, β_{2P}, and controls the individual rotor blades or their blade pitch actuators 131 accordingly.

In this way, the rotor blade 30, in its position shown in FIG. 1, comprises, for example, the collective blade pitch plus the corresponding blade pitch adjustment signals β_{1P}(p=0 degrees) and β_{2P} (ρ=0 degrees). When rotated further (ρ→ρ>0 degrees), this (total) blade pitch of the rotor blade 30 is initially reduced. Conversely, the (total) blade pitch of the other rotor blade 31 changes accordingly, so that the rotor blades each (then) (would) have the same (total) blade pitch if they (were to) assume the same pitch position relative to the nacelle (successively) about the axis of rotation R. In this case, the individual blade controls 210, 220 change the amplitude and/or phase of the respective blade pitch adjustment signal β_{1P} or β_{2P}, e.g., according to measured wind and/or blade loads or the like.

FIG. 4 shows a thrust F on or in the rotor (“rotor thrust”), the collective blade pitch βₖₒₗₗ, the torque M of the rotor or generator, its rotational velocity ω, and the electrical power Pₑₗ over a wind velocity, wherein their values are specified only by way of example.

In FIG. 4, vₙₑₙₙ designates a nominal operating point of the wind turbine or a corresponding nominal wind velocity and a partial load range T, which extends from a switch-on wind velocity vₒₙ to the nominal operating point or to the nominal wind velocity vₙₑₙₙ, as well as a full load range, which extends from the nominal operating point or the nominal wind velocity vₙₑₙₙ up to a switch-off wind velocity v_{off}.

In particular, it can be seen that, in a manner known per se, the collective blade pitch βₖₒₗₗ is increased once the nominal operating point is reached or the nominal wind velocity is increased, in order to keep the electric power as constant as possible and not overload the installation. It can also be clearly seen that the thrust on the rotor comprises a maximum in the range of the nominal operating point or the nominal wind velocity.

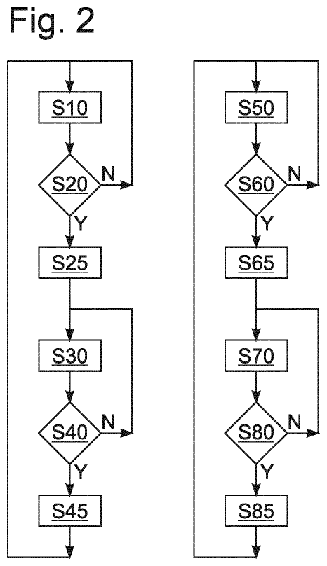

FIG. 2 shows a method for controlling the wind turbine according to one embodiment of the present invention.

In a step S10, a current value of a first operating variable, e.g., a current torque, is determined.

In step S20, the operation management system 200 checks whether the value of the first operating variable exceeds a specified lower limit value. If this is the case (S20: “Y”), it activates the 1P individual blade control 210 in a step S25, wherein it gradually increases the blade pitch adjustment signal β_{1P} specified by said signal up to the full amplitude. In this case, as the value of the first operating variable increases, the blade pitch adjustment signal, within an interval of the first operating variable specified for this purpose, is increased from zero, when the specified lower threshold value is reached, up to the full amplitude at the end of the interval. The operating management system then continues with step S30. By contrast, if the value of the first operating variable does not exceed the specified lower threshold value (S20: “N”), the operating control system returns to step S10 after step S20.

In step S30, a current value of a second operating variable, e.g., a current collective blade pitch, is determined.

In step S40, the operational management system 200 checks whether the value of the second operating variable exceeds a specified upper threshold value. If this is the case (S40: “Y”), it deactivates the 1P individual blade control 210 in a step S45, wherein, in an analogous manner, it gradually reduces the blade pitch adjustment signals β_{1P} specified by said control from the full amplitude to zero, and subsequently returns to step S10; otherwise (S40: “N”), it returns to step S30.

In parallel to this, a current value of a third operating variable, e.g., a current wind velocity or rotational velocity, is determined in a step S50.

In step S60, the operating management system 200 checks whether the value of the third operating variable exceeds a specified lower limit value. If this is the case (S50: “Y”), it activates the 2P individual blade control 220 in a step S65, wherein it gradually increases the blade pitch adjustment signals β_{2P} specified by said control up to the full amplitude in an analogous manner, and then continues with step S70; otherwise (S60: “N”), it returns to step S50.

In step S70, the value of the third operating variable is updated.

In step S80, the operating management system 200 checks whether the value of the third operating variable exceeds a specified upper limit value. If this is the case (S80: “Y”), it deactivates the 2P individual blade control 220 in a step S85, wherein, in an analogous manner, it gradually reduces the blade pitch adjustment signal β_{2P} specified by said control from the full amplitude to zero, and subsequently returns to step S50; otherwise (S80: “N”), it returns to step S70.

As shown in FIG. 2, the activation and deactivation of the 1P individual blade control and 2P individual blade control can take place independently and/or in parallel. Similarly, both activations and deactivations can also be or become linked to one another. For example, in one embodiment in which the 2P individual blade control is activated and deactivated earlier than the 1P individual blade control when the wind picks up (v↑), whether the lower threshold value (cf. S60) has been exceeded needs to be checked only if the lower limit value is exceeded, and the upper threshold value (cf. S80) checked only if the upper limit value is exceeded.

Although exemplary embodiments have been explained in the preceding description, it should be noted that a number of modifications are possible. It should also be noted that the exemplary embodiments are merely examples that are not intended to limit the scope of protection, the applications, and the construction in any way. Rather, the preceding description provides the person skilled in the art with a guide for implementing at least one exemplary embodiment, wherein various changes—in particular, with regard to the function and arrangement of the described components—can be carried out without departing from the scope of protection as arises from the claims and these equivalent feature combinations.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

10 Anemometer
11 Wind vane
20 Wind tracking actuator
30, 31 Rotor blades
40 Generator
110 Tower
120 Nacelle
130 Rotor
131 Blade pitch actuators
150 Power network
200 Operating management system with blade pitch controller
210 1P individual blade control
220 2P individual blade control
230 Collective blade control
F Thrust
G Yaw axis
M Torque
Pₑₗ Electrical power
R Axis of rotation
T Partial load range
V Full load range
β_{30/31} Blade pitch
β_{1P} Blade pitch adjustment signal (from) of the 1P individual pitch control
β_{2P} Blade pitch adjustment signal (from) of the 2P individual pitch control
βₖₒₗₗ Collective blade pitch (from) of the collective blade control
ω Rotational velocity

What is claimed is:

1-9. (canceled)

10. A method for controlling a wind turbine, the wind turbine comprising a rotor having at least two rotor blades and a 1P individual blade control configured for individual cyclical adjustment of the rotor blades about their respective longitudinal axes with a first rotor order, the wind turbine operable over a partial load range and a full load range adjoining one another at a nominal operating point, the method comprising at least one of:
activating the 1P individual blade control in response to a value of a first operating variable of the wind turbine exceeding a specified lower threshold value that the operating variable has at a first operating point of the wind turbine which is in the partial load range, the full load range, or is the nominal operating point; or
deactivating the 1P individual blade control in response to a value of the first operating variable or of a second operating variable of the wind turbine exceeding a specified upper threshold value that the first or second operating variable has below a switch-off wind velocity of the wind turbine.

11. The method of claim 10, wherein at least one of:
activating the 1P individual blade control comprises gradually increasing the 1P individual blade control;
deactivating the 1P individual blade control comprises gradually reducing the 1P individual blade control; or
deactivating the 1P individual blade control in response to a value of the first operating variable or of a second operating variable of the wind turbine exceeding a specified upper threshold value that the first or second operating variable has below a switch-off wind velocity of the wind turbine comprises deactivating the 1P individual blade control in response to a value of the first operating variable or the second operating variable of the wind turbine exceeding a specified upper threshold value that the first or second operating variable has at a second operating point of the wind turbine which is in the full load range.

12. The method of claim 10, wherein at least one of the first operating variable or the second operating variable depends on at least one of a generator torque, a rotational velocity, an electrical power produced by the wind turbine, a collective adjustment of the rotor blades about their respective longitudinal axes, a wind velocity, a blade bending torque, a rotor thrust, or a setpoint value.

13. The method of claim 12, wherein the wind velocity is averaged over a specified period of time.

14. The method of claim 10, wherein the first operating point is within a load range in which the wind turbine is at least one of:
at at least 65 percent of a nominal rotational velocity of the wind turbine;
at at most 110 percent of a nominal rotational velocity of the wind turbine;
at at least 35 percent of a nominal torque of the wind turbine;
at at most 65 percent of a nominal torque of the wind turbine;
at at least 55 percent of a thrust of the wind turbine when a nominal power of the wind turbine is reached; or
at at most 85 percent of a thrust of the wind turbine when a nominal power of the wind turbine is reached.

15. The method of claim 14, wherein the first operating point is within a load range in which the wind turbine is at at most 99 percent of the nominal rotational velocity of the wind turbine.

16. The method of claim 10, wherein the second operating point is within a load range in which at least one of:
the rotor blades are at a blade pitch of between 0 degrees and 10 degrees, or between 13 degrees and 37 degrees, inclusive;
the wind turbine is at at least 45 percent of its thrust when a nominal power of the wind turbine is reached; or
the wind turbine is at at most 75 percent of its thrust when a nominal power of the wind turbine is reached.

17. The method of claim 11, wherein at least one of the gradual increase or the gradual reduction of the 1P individual blade control is effected over an interval of at least one of:
at least 5 percent of a nominal torque of the wind turbine;
at most 45 percent of a nominal torque of the wind turbine; or
at least 2 percent of a blade pitch.

18. The method of claim 17, wherein the interval of at least 2 percent of a blade pitch is a collective blade pitch.

19. The method of claim 10, wherein the wind turbine additionally comprises an nP single blade control configured for the individual cyclical adjustment of the rotor blades about their respective longitudinal axis with an nth rotor order, and the method further comprises at least one of:
activating the nP individual blade control in response to a value of an operating variable of the wind turbine exceeding a specified lower limit value; or
deactivating the nP individual blade control in response to a value of an operating variable of the wind turbine exceeding a specified upper limit value.

20. The method of claim 19, wherein at least one of:
activating the nP individual blade control comprises gradually increasing the nP individual blade control; or
deactivating the nP individual blade control comprises gradually reducing the nP individual blade control.

21. The method of claim 19, wherein at least one of:
the lower limit value corresponds to a lower wind velocity than the lower threshold value;
the upper limit value corresponds to a lower wind velocity than the upper threshold value; or
an operating range interval of the wind turbine between the lower and upper limit values is smaller than an operating range interval of the wind turbine between the lower and upper threshold values.

22. The method of claim 21, wherein at least one of:
the operating range interval of the wind turbine is a wind velocity interval; or
the operating range interval of the wind turbine between the lower and upper limit values is smaller than an operating range interval of the wind turbine between the lower and upper threshold values by at least 20 percent.

23. A system for controlling a wind turbine, the wind turbine comprising a rotor having at least two rotor blades and a 1P individual blade control configured for individual cyclical adjustment of the rotor blades about their respective longitudinal axes with a first rotor order, the wind turbine operable over a partial load range and a full load range adjoining one another at a nominal operating point, the system comprising at least one of:
means for activating the 1P individual blade control in response to a value of a first operating variable of the wind turbine exceeding a specified lower threshold value that the operating variable has at a first operating point of the wind turbine which is in the partial load range, the full load range, or is the nominal operating point; or
means for deactivating the 1P individual blade control in response to a value of the first operating variable or of a second operating variable of the wind turbine exceeding a specified upper threshold value that the first or second operating variable has below a switch-off wind velocity of the wind turbine.

24. The system of claim 23, wherein at least one of:
the means for activating the 1P individual blade control is configured to gradually increase the 1P individual blade control;
the means for deactivating the 1P individual blade control is configured to gradually reduce the 1P individual blade control; or
the switch-off wind velocity of the wind turbine is at a second operating point of the wind turbine which is in the full load range.

25. A computer program product for controlling a wind turbine, the wind turbine comprising a rotor having at least two rotor blades, a 1P individual blade control configured for individual cyclical adjustment of the rotor blades about their respective longitudinal axis with a first rotor order, the wind turbine operable over a partial load range and a full load range adjoining one another at a nominal operating point, the computer program product having a program code stored on a non-transitory, computer-readable medium, the program code configured, when executed by a computer, to cause the computer to at least one of:
activate the 1P individual blade control in response to a value of a first operating variable of the wind turbine exceeding a specified lower threshold value that the operating variable has at a first operating point of the wind turbine which is in the partial load range, the full load range, or is the nominal operating point; or
deactivate the 1P individual blade control in response to a value of the first operating variable or of a second operating variable of the wind turbine exceeding a specified upper threshold value that the first or second operating variable has below a switch-off wind velocity of the wind turbine.

26. The computer program product of claim 25, wherein at least one of:
activating the 1P individual blade control comprises gradually increasing the 1P individual blade control;
deactivating the 1P individual blade control comprises gradually reducing the 1P individual blade control; or
the switch-off wind velocity of the wind turbine is at a second operating point of the wind turbine which is in the full load range.
